(19) United States
(12) Patent Application Publication
(10) Pub. No.: US 2023/0286676 A1
(43) Pub. Date: Sep. 14, 2023

(54) SOLAR PARASOL

(71) Applicant: Gary Schmelz, Newark, DE (US)

(72) Inventor: Gary Schmelz, Newark, DE (US)

(21) Appl. No.: 18/182,015

(22) Filed: Mar. 10, 2023

Related U.S. Application Data
(60) Provisional application No. 63/269,179, filed on Mar. 11, 2022.

(51) Int. Cl. B64G 1/54; B64G 1/24

(52) U.S. Cl. CPC B64G 1/54; B64G 1/242; G02B 1/04

(57) ABSTRACT

A method of reducing solar irradiance the Earth receives includes placing a solar parasol in sun-synchronous orbit between the Earth and the Sun. The solar parasol provides a reflective shield that faces the Sun. The reflective shield is supported by a frame and a method of positioning the solar parasol in sun-synchronous orbit. The shield may include a coating layer and a gold film layered over the coating layer on the sun-facing surface of the shield, while a heat sink is provided on an opposing surface of the shield.

### CROSS-REFERENCE TO RELATED APPLICATION

This application claims the benefit of priority of U.S. provisional application No. 63/269,179, filed Mar. 11, 2022, the contents of which are herein incorporated by reference.

### BACKGROUND OF THE INVENTION

The present invention relates to solar radiation and, more particularly, to a solar parasol and methods of shielding the Earth from solar irradiance.

At Earth's average distance from the Sun (about 150 million kilometers), the average intensity of solar energy reaching the top of the atmosphere directly facing the Sun is about 1,360 watts per square meter, according to measurements made by NASA satellite missions. This amount of power is known as total solar irradiance. This heat energy is the largest source of heat warming Earth's surface. Heat is also coming from the core of the earth due to compression of the Earth itself. This heat migrates up through the surface. Heat travels from a hotter source to a lower temperature area. This total amount of heat is transferred to the environment, i.e., our atmosphere, and eventually lost to space. Our planet balances this heat gain with heat loss and yields our Earth's average temperature.

However, the amount of heat lost can be hindered by gases generated on Earth, either naturally or by humans. Several attempts have been made to restrict the amount and number of gases created by manufacturing processes, energy production, or by how we use everyday devices, such as our automobiles and light bulbs. Each hour 430 quintillion Joules of energy from the sun hits the Earth. That's 430 with 18 zeroes after it. In comparison, the total amount of energy that all humans use in a year is 410 quintillion Joules. For context, the average American home used 39 billion Joules of electricity in 2013.

Some practices to harness natural energy are currently impracticable, such as the manufacturing of windmills and solar panels. The cost of their production is either too expensive, or the process creates byproducts that are more hazardous to the environment than they save in energy production. Reducing the energy our Earth receives every hour will help reduce global warming.

As can be seen, there is a need for a device for reducing the amount of energy received by the Sun.

### SUMMARY OF THE INVENTION

Broadly, an embodiment of the present invention provides a parasol to be positioned in the Earth's atmosphere to reflect solar energy.

In some embodiments of the present invention, at least one solar parasol sits in sun-synchronous orbit, approximately 450 miles above Earth's surface. These solar parasols sit between the Sun and the Earth and reflect the Sun's energy away from the Earth, acting as a shield.

The present invention embodies two (2) deployment phases: phase one is the use of mylar film secured to a carbon fiber frame, thereby defining the solar radiation shield. Deployment of phase one may last for twenty years. Phase two is utilizing and deploying the aluminum panels (approximately 10′ by 10′ panels joined together to form a new solar radiation shield) with a gold and beryllium coating to reflect the Sun's light. Deployment of phase two should last approximately 30 to 40 years.

In some embodiments of the present invention, three solar parasols may block energy from the Sun: two solar parasols located over the North or South Poles, respectively and a third solar parasol disposed over the Earth's equator. The arrangement of the three solar parasols may lower or slow Earth's rising temperature and subsequently lower or slow a rise of ocean levels. The solar parasol located over Earth's equator may stop or slow Earth's average rising temperature.

The equator is zero degrees, and thus the North and South Poles are ninety degrees latitude from the equator. The deployment of the parasols over the Poles should be approximately 80 to 85-degrees, latitudinally, offset from the equator to block the Sun effectively. In one embodiment, the parasol runs for one mile by one mile over the equator. The solar parasols over the Poles are approximately one mile by half a mile, wherein the one-mile parameter extends longitudinally to block the sun rays for approximately 30 seconds. It being understood that the dimensions may be adjusted in different embodiments.

Three solar parasols, being deployed in this configuration will block enough solar energy to stop the current rise of the earth's atmospheric temperature and slow the melting of the polar caps.

The parasols may be made of a large blanket supported by a substrate or frame composed of carbon fiber rods and a positioning system. The positioning system may be controlled by NASA. Parts of the parasol may will be launched into space for assembly. They may then be assembled and positioned outside of or within Earth's atmosphere.

In some embodiments of the present invention, frame may hold a sheet. The equator's frame may be 1-mile by 1-mile, while the polar frame may be 1-mile by 0.5-mile. The sheet may be a reflective mylar film. A positioning rocket may be in each corner of the frame. The positioning rockets assist in maintaining a stable orbit and altitude. Additional positioning rockets may be added to the frame or solar parasol.

In some embodiments of the present invention, the mylar film may be highly reflective. It may be painted or colored black on a surface facing the Earth. The frame may be composed of 25-foot lengths with a twist lock connector between each length. The mylar may be connected to the frame by a hook and loop fastener such as Velcro™.

In some embodiments of the present invention, multiple mylar film blocks, approximately 10 feet and 4 inches by 10 feet and 4 inches, may be connected by hook and loop fasteners. The blocks may be joined to form the sheet. The blocks may also be connected by bolts. The sheet may be one mile by one mile (i.e., one square mile). A surface of the sheet facing the sun may be a highly reflective substance (e.g., mylar film).

As mentioned above, in some embodiments of the present invention there are two phases of placing the solar parasols into sun synchronous orbits. Phase one places the three previously described mylar film solar parasols into orbit between the earth's equator and the sun and between the earth's polar caps and the sun. Phase two will be the placement of aluminum panels constructed to be the same dimension of phase one's panels of 1 square mile panel to be at the equator and two panels at 0.5 square miles to be at each of the Earth's polar caps. These solid panels will be made of smaller panels each peel being constructed at approximately 10′-4″ by 10′-4″. The sun facing side of each panel being coated with beryllium then coated with a highly reflective surface such as a thin gold layer of approximate one gold atom thick. A surface facing the earth may be black and include a lightweight aluminum alloy. The phase two solar parasols will be placed in orbit to be adjacent to the phase one solar parasols.

The parasols embodied in the present invention may benefit Earth's climate by slowing or stopping a rise in global temperature.

In one aspect of the present invention, a method of reducing solar irradiance the Earth receives includes placing a solar parasol in sun-synchronous orbit between the Earth and the Sun, wherein the solar parasol is located over the equator of the Earth.

In another aspect of the present invention, a solar parasol for a sun-synchronous orbit, the solar parasol includes the following: a frame; a positioning system controlling a position of the solar parasol in the sun-synchronous orbit; and a shield covering a center of the frame wherein the shield includes a reflective coating on a surface facing the Sun, wherein the positioning system comprises a positioning rocket on each corner of the frame, wherein the reflective coating is mylar film, wherein a surface of the shield facing the Earth is entirely black in surface color, wherein the shield comprises a plurality of film blocks joined by hook and loop fasteners, wherein the frame comprises a plurality of connecting rods, wherein the shield comprises a plurality of sheets connected to the plurality of connecting rods by way of hook and loop fasteners; and further including a triangular reinforcement plate at each corner of the frame.

In yet another aspect of the present invention, an aluminum parasol positioned in a sun-synchronous orbit, the aluminum parasol includes the following: a frame; and a plurality of aluminum panels interconnected forming a shield that covers a center of the frame, wherein an interconnection between adjacent aluminum panels is formed by hook and loop fasteners or magnets, wherein each aluminum panel has a handle on one end and a lip on an opposing end, wherein each handle is dimensioned to operatively associated with, separately, each lip forming the interconnection, wherein each handle has a lap joint for operatively associating with, separately, each lip, wherein each aluminum panel comprises, along the shield: a coating layer; and a gold film layered over the coating layer, wherein the gold film faces the Sun in the sun-synchronous orbit, wherein the coating layer comprises beryllium, wherein each aluminum panel comprises a heat sink along a surface of the shield that faces the Earth in the sun-synchronous orbit.

These and other features, aspects and advantages of the present invention will become better understood with reference to the following drawings, description, and claims.

### BRIEF DESCRIPTION OF THE DRAWINGS

FIG. 1 is a top plan view of a solar parasol according to an embodiment of the present invention.

FIG. 2 is a sectional view of a frame according to an embodiment of the present invention.

FIG. 3 is a detail view of a connector rod according to an embodiment of the present invention.

FIG. 4 is a detail view of a corner of the frame according to an embodiment of the present invention.

FIG. 5 is a front view of a fluted grip knob according to an embodiment of the present invention.

FIG. 6 is a detail view of the connector rod according to an embodiment of the present invention.

FIG. 7 is a top plan view of an aluminum parasol panel according to an embodiment of the present invention.

FIG. 8 is a front view of the aluminum parasol panel according to an embodiment of the present invention.

FIG. 9 is a detail view of FIG. 8;

FIG. 10 is a detail view of the aluminum parasol panel according to an embodiment of the present invention.

FIG. 11 is a detail view of the aluminum parasol panel according to an embodiment of the present invention.

FIG. 12 is a detail view of the aluminum parasol panel according to an embodiment of the present invention; and

FIG. 13 is a detail view of the aluminum parasol panel according to an embodiment of the present invention.

FIG. 14 is an elevation view of the aluminum parasol assembled by four connected aluminum parasol panels according to an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

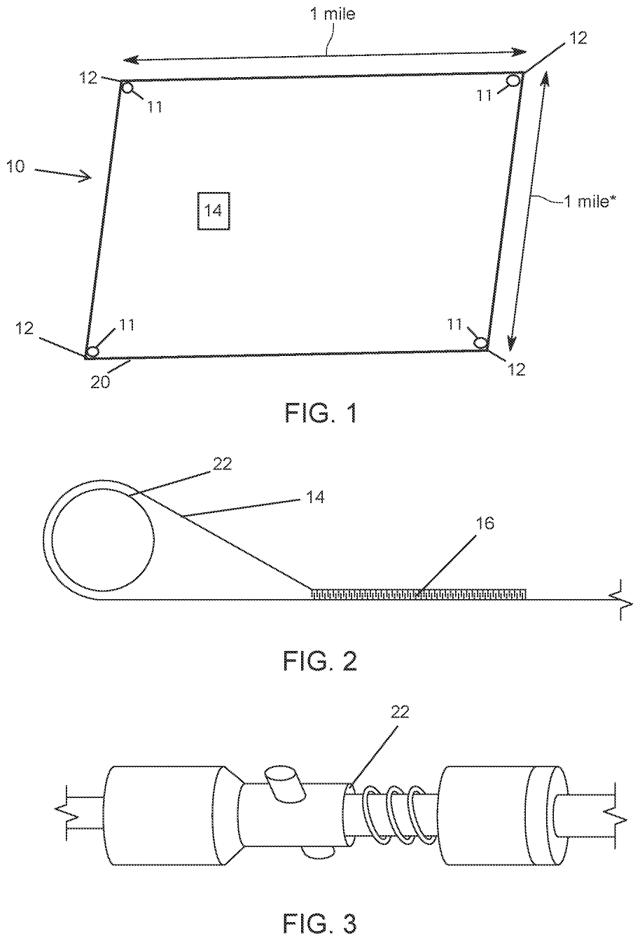

Referring now to the Figures, FIG. 1 shows a solar parasol 10 according to an embodiment of the present invention. The solar parasol 10 may be one mile by one mile in length and width. A positioning rocket 11 may be in each corner 12 of the solar parasol 10. A frame 20 may surround the solar parasol with a sheet 14 in a center.

FIG. 2 is a sectional view of the sheet 14 connected to the frame 20. The frame includes a connector rod 22. The sheet 14 is composed of mylar film. The sheet 14 wraps around the connector rod 22 and attaches to itself via a hook and loop fastener 16, thereby the sheet 14 may extend between opposing frame rods 22.

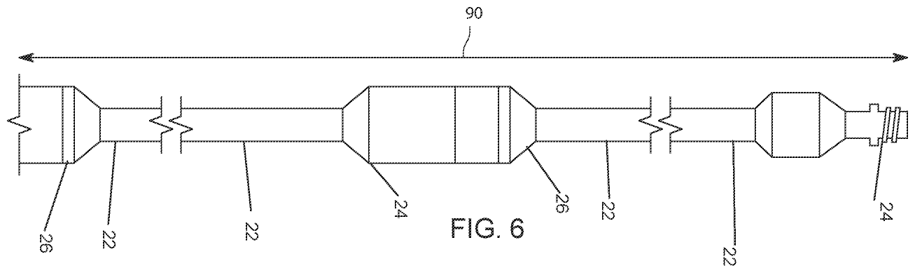

FIGS. 3 and 6 show detail views of the connector rod 22. The connector rod 22 may have a length 90 that may be between eight or twelve feet or greater or lesser lengths. Multiple connector rods 22 may be joined to form the frame 20. The connector rod 22 has a male connector 24 and a female connector 26. The male connector 24 and female connector 26 may be joined to connect multiple connector rods.

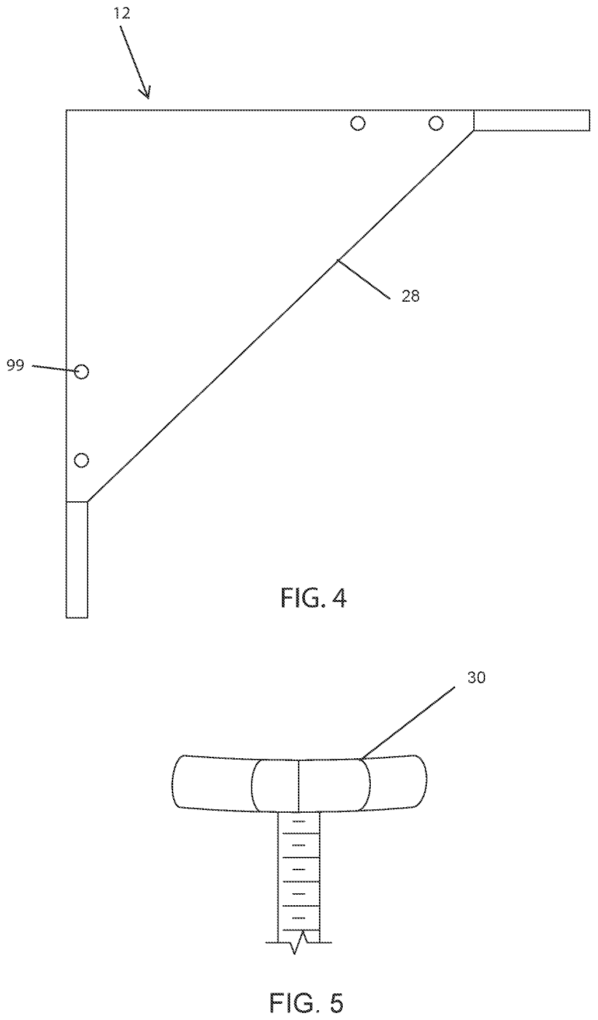

FIG. 4 is a detail view of a corner 12 of the frame 20. The corner 12 is reinforced with a triangular plate 28. A fluted grip knob 30, as shown in FIG. 5, may be used to tighten or loosen the connector rods 22 in the frame 20. The fluted knob 30 may inserted through the frame 20 and into the triangular plate 12. Each triangular plate 12 and connector rod 22 has holes 99 (that align during assembly) that are threaded and tapped or otherwise configured to receive or otherwise operatively associate with the threaded shaft of part 30 for tighten or loosen the connector rod 22 relative the triangular plate 12. The triangular plate 12 enable the positioning rocket 11 to engage the triangular plate 12 necessitating, in some situations, the use of the fluted grip knob 30 tightening.

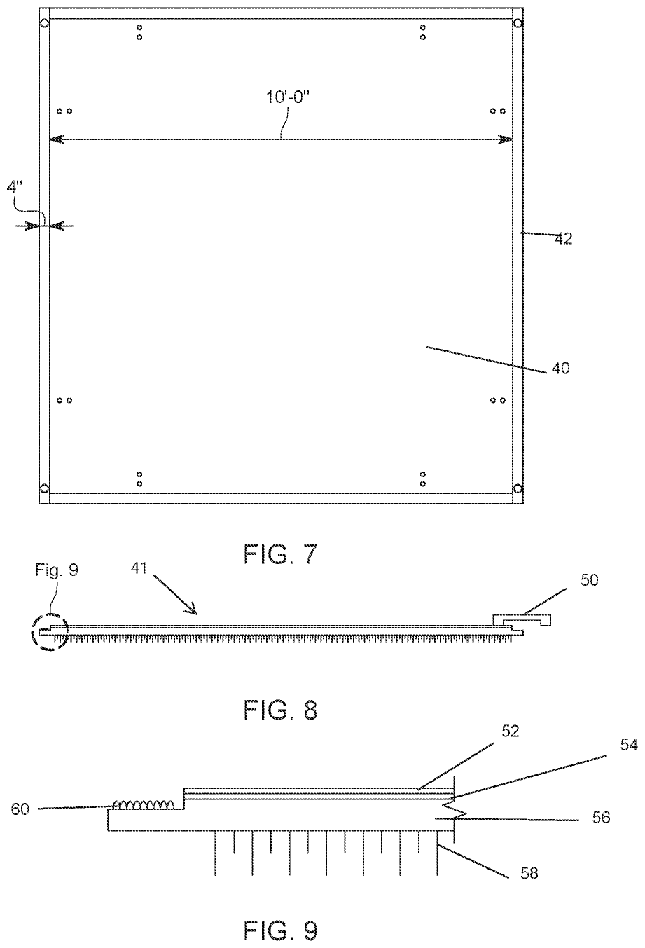

FIG. 7 shows a top view of an aluminum parasol panel 40. The aluminum parasol panel 40 may be approximately 10′-0″ by 10′-0″ aluminum plate that will lock onto other similar plates to form a rigid, long-term parasol. When fully constructed, it will be of the same dimensions as the solar parasol 10 displayed in FIG. 1. This aluminum parasol may replace or complement the solar parasol 10. Its construction will be able to withstand small meteors with little loss of form or function. The aluminum parasol panel 40 may have a length of ten feet and be connected to a frame 42 approximately four inches in width.

FIG. 8 is a front view an embodiment of an aluminum parasol panel 41. The panel 41 may have a handle 50 at a first end. FIG. 9 is a detail view of the panel 41 of FIG. 8. An aluminum panel 40, 41 may connect to another aluminum panel 40, 41 with either a hook and loop fabric or with magnets until a firm connection is formed by bolting each plate via the handle 50. The handle 50 connection will ensure each aluminum panel 40, 41 remains a rigid construction of the aluminum parasol. The panel 41 is composed of a gold layer 52, a coating layer 54, aluminum 56, and a thermal heat sink 58. The coating layer 54 may be beryllium, polished mylar, or polished aluminum. A second end of the panel 41 contains a lip 60. The lip 60 may fit into a lap joint 70 shown in FIG. 10. The gold layer 52 is placed onto of a beryllium layer 54 on the side facing the Sun. The opposite side, facing towards the Earth, has a hard heat dissipation sheet 58 on it to allow all heat collected to be transferred harmlessly into space.

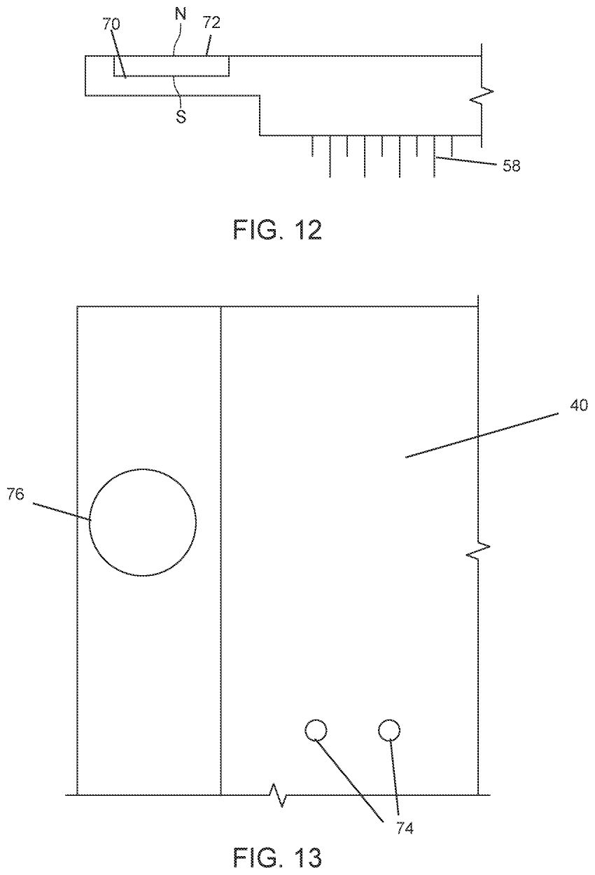

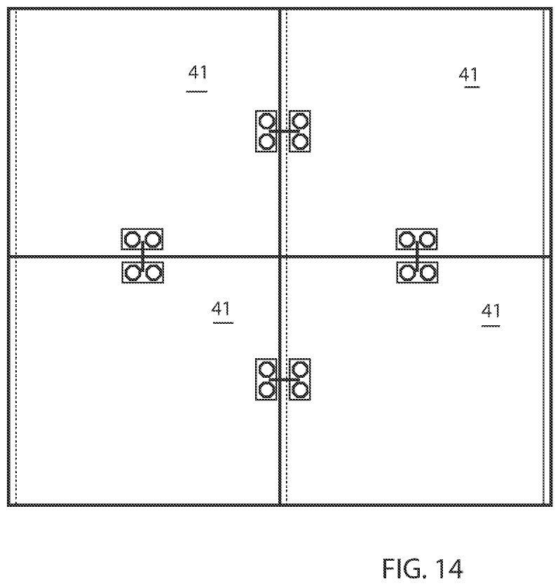

FIGS. 10 and 12 are a detail view of the aluminum parasol panel 40. The aluminum parasol panel 40 comprises a thermal heat sink 58 and a lap joint 70. As shown in FIG. 12, the lap joint 70 houses a magnet 72. Alternatively, a hook and loop fastener may be housed in the lap joint 70.

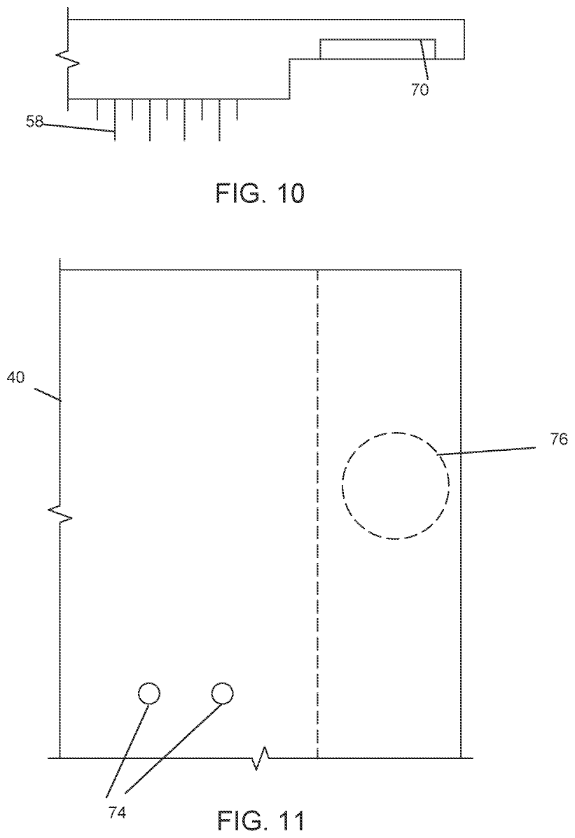

FIGS. 11 and 13 are a top view of the aluminum parasol panel 40. Screw holes 74 may accommodate a connection of a handle. A fastener 76 such as a hook and loop fastener or a magnet is on an outside end of the aluminum parasol panel 40.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention

What is claimed is:

1. A method of reducing solar irradiance the Earth receives, the method comprises placing a solar parasol in sun-synchronous orbit between the Earth and the Sun.

2. The method of claim 1, wherein the solar parasol is located over the equator of the Earth.

3. A solar parasol for a sun-synchronous orbit, the solar parasol comprising:
a frame;
a positioning system controlling a position of the solar parasol in the sun-synchronous orbit; and
a shield covering a center of the frame wherein the shield includes a reflective coating on a surface facing the Sun.

4. The solar parasol of claim 3, wherein the positioning system comprises a positioning rocket on each corner of the frame.

5. The solar parasol of claim 3, wherein the reflective coating is mylar film.

6. The solar parasol of claim 3, wherein a surface of the shield facing the Earth is entirely black in surface color.

7. The solar parasol of claim 3, wherein the shield comprises a plurality of film blocks joined by hook and loop fasteners.

8. The solar parasol of claim 3, wherein the frame comprises a plurality of connecting rods.

9. The solar parasol of claim 8, wherein the shield comprises a plurality of sheets connected to the plurality of connecting rods by way of hook and loop fasteners.

10. The solar parasol of claim 8, further comprising a triangular reinforcement plate at each corner of the frame.

11. An aluminum parasol positioned in a sun-synchronous orbit, the aluminum parasol comprising:
a frame; and
a plurality of aluminum panels interconnected forming a shield that covers a center of the frame;
wherein an interconnection between adjacent aluminum panels is formed by hook and loop fasteners or magnets.

12. The aluminum parasol of claim 11, wherein each aluminum panel has a handle on one end and a lip on an opposing end, wherein each handle is dimensioned to operatively associated with, separately, each lip forming the interconnection.

13. The aluminum parasol of claim 12, wherein each handle has a lap joint for operatively associating with, separately, each lip.

14. The aluminum parasol of claim 13, wherein each aluminum panel comprises, along the shield:
a coating layer; and
a gold film layered over the coating layer, wherein the gold film faces the Sun in the sun-synchronous orbit.

15. The aluminum parasol of claim 14, wherein the coating layer comprises beryllium.

16. The aluminum parasol of claim 15, wherein each aluminum panel comprises a heat sink along a surface of the shield that faces the Earth in the sun-synchronous orbit.
